(19) United States
(12) Patent Application Publication
(10) Pub. No.: US 2007/0202341 A1
(43) Pub. Date: Aug. 30, 2007

(54) Multilayer Coating System

(76) Inventors: Nazire Dogan, Leiden (NL); Josef Pancratius Maria Jonker, Sassenheim (NL); Robertus Petrus Cornelis Van Der Krogt, Sassenheim (DE); Peter Wijnands, Sassenheim (NL)

Correspondence Address: KENYON & KENYON LLP, ONE BROADWAY, NEW YORK, NY, 10004, US

(21) Appl. No.: 11/629,960

(22) PCT Filed: Jun. 17, 2005
(86) PCT No.: PCT/EP05/52810

§ 371 Date: Mar. 28, 2007

Related U.S. Application Data
(60) Provisional application No. 60/588,787, filed on Jul. 19, 2004.

(30) Foreign Application Priority Data
Jun. 18, 2004 (EP) 04076786.5

(51) Int. Cl. B32B 27/40

(52) U.S. Cl. 428/423.1; 428/425.8; 428/480

(57) ABSTRACT

The invention relates to a multi-layer coating system comprising: at least one layer a) comprising a coating composition a) comprising at least one isocyanate-functional compound and at least one thiol-functional compound; and at least one layer b) comprising a non-aqueous coating composition b), wherein at least one layer a) and at least one layer b) have at least one common layer boundary, and wherein coating composition b) comprises all effective amount of a catalyst for the addition reaction of tile at least one thiol-functional compound and the at least one isocyanate-functional compound.

The invention relates to a multilayer coating system comprising at least one layer a) comprising a coating composition a) comprising at least one isocyanate-functional compound and at least one thiol-functional compound, and at least one layer b) comprising a non-aqueous coating composition b), wherein at least one layer a) and at least one layer b) have at least one common layer boundary. The invention also relates to a process of preparing the multilayer coating system, and to a kit of parts for preparation of a base coat composition.

U.S. Pat. No. 5,578,346 describes multilayer composite coatings which comprise (a) a first coat which is substantially free of isocyanate functionality and which comprises a film-forming composition capable of curing or drying and a catalyst for the reaction of isocyanate groups and active hydrogen groups, and (b) a second coat which is applied to the surface of the first coat and which comprises an active hydrogen compound and a polyisocyanate. Examples wherein the first coat comprises dibutyl tin dilaurate and the second coat is based on a polyol and a polyisocyanate are described.

International patent application WO 0192362 describes a photoactivatable coating composition comprising a photolatent base and a base-catalyzed polymerizable or curable organic material comprising at least one polyisocyanate and at least one compound containing at least one thiol group. The photoactivatable coating composition can be a clear coat composition which is to be applied on top of a base coat composition. The photoactivatable coating composition has a long pot life and exhibits fast curing upon irradiation with ultraviolet and visible light. The known photoactivatable coating composition eventually also cures in shadow areas, i.e. those areas of a coated substrate which are not exposed to ultraviolet or visible light.

A drawback of the known multilayer coating systems is that upon application of a clear coat swelling of the underlying base coat layer frequently occurs when the base coat layer is produced from a non-aqueous base coat composition. Swelling of the base coat layer disturbs the orientation of effect-pigment particles, such as aluminium leaflets, in the base coat layer. Even minor disorientation of the effect-pigment particles leads to relatively large visual effects, e.g. colour differences. This undesirable phenomenon is commonly referred to as “strike-in”.

Furthermore, the curing speed of the top coats of the known systems is not always as fast as desirable. Fast curing of the photoactivatable coating composition according to WO 0192362 is only achieved upon irradiation with visible and/or ultraviolet light, while the curing speed in shadow areas is rather slow and subject to further improvement.

The current invention seeks to alleviate the above-mentioned drawbacks of the known multilayer coating systems. More in particular, if the coating composition comprising at least one isocyanate-functional compound and at least one thiol-functional compound is a clear coat composition, it is desirable that application of the clear coat should lead to only minimal or even no strike-in effect in an underlying base coat layer.

In another aspect, the coating composition comprising at least one isocyanate-functional compound and at least one thiol-functional compound should be rapidly curable also in shadow areas or even without any irradiation with visible and/or ultraviolet light. Rapid curability should not be achieved at the expense of the pot life of the composition.

It has now been found that these objectives can be achieved with a multilayer coating system comprising
at least one layer a) comprising a coating composition a) comprising at least one isocyanate-functional compound and at least one thiol-functional compound, and
at least one layer b) comprising a non-aqueous coating composition b),

wherein at least one layer a) and at least one layer b) have at least one common layer boundary, and wherein coating composition b) comprises an effective amount of a catalyst for the addition reaction of the at least one thiol-functional compound and the at least one isocyanate-functional compound.

In the multilayer coating system according to the invention, application of a clear coat composition of coating composition a) leads to minimal or even no strike-in effect in an underlying base coat layer produced from a non-aqueous base coat composition b).

Furthermore, coating composition a) comprising at least one isocyanate-functional compound and at least one thiol-functional compound cures rapidly also in shadow areas or even without any irradiation with visible and/or ultraviolet light. Since no additional components, such as a catalyst, need to be added to coating composition a), the pot life of coating composition a) is not decreased. Thus, rapid curability is not achieved at the expense of the pot life of the composition.

The invention also relates to a method of reducing the strike-in effect in a multi-layer coating system. The method comprises applying a clear coat composition a) comprising at least one isocyanate-functional compound and at least one thiol-functional compound on top of a base coat layer b) prepared from a non-aqueous base coat composition b) comprising an effective amount of a catalyst for the addition reaction of the at least one thiol-functional compound and the at least one isocyanate-functional compound.

Suitable isocyanate-functional compounds for use in coating composition a) are isocyanate-functional compounds comprising at least one isocyanate group. Preferably, the isocyanate-functional compound in coating composition a) is a polyisocyanate, such as an aliphatic, cycloaliphatic or aromatic di-, tri- or tetra-isocyanate. Examples of diisocyanates include 1,2-propylene diisocyanate, rimethylene diisocyanate, tetramethylene diisocyanate, 2,3-butylene diisocyanate, hexamethylene diisocyanate, octamethylene diisocyanate, 2,2,4-trimethyl hexamethylene diisocyanate, dodecamethylene diisocyanate, ω,ω′-dipropylether diisocyanate, 1,3-cyclopentane diisocyanate, 1,2-cyclohexane diisocyanate, 1,4-cyclohexane diisocyanate, isophorone diisocyanate, 4-methyl-1,3-diisocyanatocyclohexane, trans-vinylidene diisocyanate, dicyclohexyl methane-4,4′-diisocyanate (Desmodur® W), toluene diisocyanate, 1,3-bis(isocyanatomethyl) benzene, xylylene diisocyanate, α,α,α′,α′-tetramethyl xylylene diisocyanate (TMXDI®), 1,5-dimethyl-2,4-bis(2-isocyanatoethyl) benzene, 1,3,5-triethyl-2,4-bis(isocyanatomethyl) benzene, 4,4′-diisocyanato-diphenyl, 3,3′-dichloro-4,4′-diisocyanato-diphenyl, 3,3′-diphenyl-4,4′-diisocyanato-diphenyl, 3,3′-dimethoxy-4,4′-diisocyanato-iphenyl, 4,4′-diisocyanato-diphenyl methane, 3,3′-dimethyl-4,4′-diisocyanato-diphenyl-methane, and diisocyanatonaphthalene. Examples of triisocyanates include 1,3,5-triisocyanatobenzene, 2,4,6-triisocyanatotoluene, 1,8-diisocyanato-4-(isocyanatomethyl) octane, and lysine triisocyanate. Adducts and oligomers of polyisocyanates, for instance biurets, isocyanurates, allophanates, uretdiones, urethanes, and mixtures thereof are also included. Examples of such oligomers and adducts are the adduct of 2 molecules of a diisocyanate, for example hexamethylene diisocyanate or isophorone diisocyanate, to a diol such as ethylene glycol, the adduct of 3 molecules of hexamethylene diisocyanate to 1 molecule of water (available under the trademark Desmodur N of Bayer), the adduct of 1 molecule of trimethylol propane to 3 molecules of toluene diisocyanate (available under the trademark Desmodur L of Bayer), the adduct of 1 molecule of trimethylol propane to 3 molecules of isophorone diisocyanate, the adduct of 1 molecule of pentaerythritol to 4 molecules of toluene diisocyanate, the adduct of 3 moles of m-α,α,α′,α′-tetramethyl xylene diisocyanate to 1 mole of trimethylol propane, the isocyanurate trimer of 1,6-diisocyanatohexane, the isocyanurate trimer of isophorone diisocyanate, the uretdion dimer of 1,6-diisocyanatohexane, the biuret of 1,6-diisocyanatohexane, the allophanate of 1,6-diisocyanatohexane, and mixtures thereof. Furthermore, (co)polymers of isocyanate-functional monomers such as α,α′-dimethyl-m-isopropenyl benzyl isocyanate are suitable for use.

The polyisocyanate can comprise hydrophilic groups, for example covalently bonded hydrophilic polyether moieties, which facilitate the formation of aqueous dispersions.

Thiol-functional compounds that can suitably be used in coating composition a) include dodecyl mercaptan, mercapto ethanol, 1,3-propanedithiol, 1,6-hexanedithiol, methylthioglycolate, 2-mercaptoacetic acid, mercaptosuccinic acid, and cysteine.

Also suitable-are esters of a thiol-functional carboxylic acid with a polyol, such as esters of 2-mercaptoacetic acid, 3-mercaptopropionic acid, 2-mercapto-propionic acid, 11-mercaptoundecanoic acid, and mercaptosuccinic acid. Examples of such esters include pentaerythritol tetrakis (3-mercapto-propionate), pentaerythritol tetrakis (2-mercaptoacetate), trimethylol propane tris (3-mercaptopropionate), trimethylol propane tris (2-mercaptopropionate), and trimethylol propane tris (2-mercaptoacetate). A further example of such a compound consists of a hyperbranched polyol core based on a starter polyol, e.g. trimethylol propane and dimethylol propionic acid, which is subsequently esterified with 3-mercaptopropionic acid and isononanoic acid. These compounds are described in European patent application EP 0448224 A and International patent application WO 9317060.

Addition products of H₂S to epoxy-functional compounds also give thiol-functional compounds. These compounds may have a structure of the following formula T[(O—CHR—CH₂—O)ₙCH₂CHXHCH₂YH]ₘ, with T being a m valent organic moiety wherein m is an integer between 1 and 25, R being hydrogen or methyl, n being an integer between 0 and 30, X and Y being oxygen or sulfur, with the proviso that X and Y are not equal. An example of such a compound is commercially available from Cognis under the trademark Capcure® 3/800. Other syntheses to prepare compounds comprising thiol-functional groups involve: the reaction of an aryl or alkyl halide with NaHS to introduce a pendant mercapto group into the alkyl and aryl compounds, respectively; the reaction of a Grignard reagent with sulfur to introduce a pendant mercapto group into the structure; the reaction of a polymercaptan with a polyolefin according to a nucleophilic reaction, an electrophilic reaction or a radical reaction; the reaction of disulfides.

Preferred thiol-functional compounds are pentaerythritol tetrakis(3-mercapto propionate), trimethylolpropane tris(3-mercaptopropionate), and Capcure 3/800. In another embodiment of the invention the thiol group of the thiol-functional compound in coating composition a) can be covalently attached to a resin. Such resins include thiol-functional polyurethane resins, thiol-funcfional polyester resins, thiol-functional polyaddition polymer resins, thiol-functional polyether resins, thiol-functional polyamide resins, thiol-functional polyurea resins, and mixtures thereof. Thiol-functional resins can be prepared by the reaction of H₂S with an epoxy group or an unsaturated carbon-carbon bond-containing resin, the reaction between a hydroxyl-functional resin and a thiol-functional acid, and by the reaction of an isocyanate-functional polymer and either a thiol-functional alcohol or a di- or polymercapto compound.

A thiol-functional polyurethane resin can be the reaction product of a mono-, di-, tri- or tetrafunctional thiol compound with an isocyanate-terminated polyurethane and preferably is the reaction product of a diisocyanate compound and (a) diol-functional compound(s). Suitable thiol-functional polyurethane resins are obtainable by first preparing an isocyanate-functional polyurethane from diols, diisocyanates, and optionally building blocks containing groups which facilitate the stabilization of the resin in an aqueous dispersion, followed by reaction of the isocyanate-functional polyurethane with a polyfunctional thiol in a base-catalyzed addition reaction. Other thiol-functional polyurethane resins are known and described, e.g., in German patent publication DE 2642071 A and European patent application EP 0794204 A.

The thiol-functional resin can be a polyester prepared from (a) at least one polycarboxylic acid or reactive derivatives thereof, (b) at least one polyol, and (c) at least one thiol-functional carboxylic acid. The polyesters preferably possess a branched structure. Branched polyesters are conventionally obtained through condensation of polyearboxylic acids or reactive derivatives thereof, such as the corresponding anhydrides or lower alkyl esters, with polyalcohols, when at least one of the reactants has a functionality of at least 3.

Examples of suitable polycarboxylic acids or reactive derivatives thereof are tetrahydrophthalic acid, tetrahydrophthalic anhydride, hexahydrophthalic acid, hexahydrophthalic anhydride, methyl hexahydrophthalic acid, methyl hexahy-drophthalic anhydride, dimethylcyclohexane dicarboxylate, 1,4-cyclohexane dicarboxylic acid, 1,3-cyclohexane dicarboxylic acid, phthalic acid, phthalic anhydride, isophthalic acid, terephthalic acid, 5-tert. butyl isophthalic acid, trimellitic anhydride, maleic acid, maleic anhydride, fumaric acid, succinic acid, succinic anhydride, dodecenyl succinic anhydride, dimethyl succinate, glutaric acid, adipic acid, dimethyl adipate, azelaic acid, and mixtures thereof. Examples of suitable polyols include trimethylol propane, trimethylol ethane, glycerol, 1,2,6-hexanetriol, ethylene glycol, 1,2-propylene glycol, 1,3-propylene glycol, 2-methylpropane-1,3-diol, neopentyl glycol, 2-butyl-2-ethyl-1,3-propane diol, cyclohexane-1,4-dimethylol, the monoester of neopentyl glycol and hydroxypivalic acid, hydrogenated Bisphenol A, 1,5-pentane diol, 3-methyl-pentane diol, 1,6-hexane diol, 2,2,4-trimethyl pentane-1,3-diol, dimethylol prppionic acid, pentaerythritol, di-trimethylol propane, diperdaerythritol, and mixtures thereof.

Examples of suitable thiol-functional organic acids include 3-mercaptopropionic acid, 2-mercaptopropionic acid, thio-salicylic acid, mercaptosuccinic acid, mercaptoacetic acid, cysteine, and mixtures thereof.

Optionally, monocarboxylic acids and monoalcohols may be used in the preparation of the polyesters. Preferably, C₄-C₁₈ monocarboxylic acids and C₆-C₁₈ monoalcohols are used. Examples of the C₄-C₁₈ monocarboxylic acids include pivalic acid, hexanoic acid, heptanoic acid, octanoic acid, nonanoic acid, 2-ethylhexanoic acid, isononanoic acid, decanoic acid, lauric acid, myristic acid, palmitic acid, isostearic acid, stearic acid, hydroxystearic acid, benzoic acid, 4-tert. butyl benzoic acid, and mixtures thereof. Examples of the C₆-C₁₈ monoalcohols include cyclohexanol, 2-ethylhexanol, stearyl alcohol, and 4-tert. butyl cyclohexanol.

In addition to thiol groups, the thiol-functional polyester prepared from the above components may also comprise hydroxyl groups.

The thiol-functional resin can be a thiol-functional polyaddition polymer, for example a poly(meth)acrylate. Such a poly(meth)acrylate is derived from hydroxyl-functional (meth)acrylic monomers, such as hydroxyethyl (meth)acrylate, hydroxypropyl (meth)acrylate, hydroxybutyl (meth)acrylate, and other ethylenically unsaturated polymerizable monomers as described above for the polyaddition polymer preparation. The thiol group is introduced by esterification of (part of) the hydroxyl groups of the acrylate copolymer with one or more of the thiol-functional carboxylic acids described above.

Alternatively, glycidyl methacrylate is introduced into the polymer to prepare an epoxy-functional poly(meth)acrylate. The epoxy groups are then reacted with suitable thiol-functional carboxylic acids such as mentioned above. Alternatively, the thiol group can be introduced by reacting an isocyanate-functional polyacrylate with a thiol-functional alcohol, e.g., mercapto ethanol. The polyaddition polymer is prepared by conventional methods as described above, for instance by the slow addition of appropriate monomers to a solution of an appropriate polymerization initiator, such as an azo or peroxy initiator.

Coating composition a) in the multilayer system according to the present invention may be a water borne composition, a solvent borne composition or a solvent-free composition. Since the composition may be composed of liquid oligomers, it is especially suitable for use as a high-solids composition or a solvent-free composition. Alternatively, coating composition a) may be an aqueous powder coating dispersion wherein the thiol-functional compound is a resin having a Tg above 20° C. The coating composition may also be used in powder coating compositions and hot melt coating compositions. Preferably, the theoretical volatile organic content (VOC) in coating composition a) is less than 450 g/l, more preferably less than 350 g/l, most preferably less than 250 g/l.

It is preferred that coating composition a) comprises a combination of pentaerythritol tetrakis(3-mercapto propionate) and a thiol-functional polyester. It is particularly preferred that the thiol4unctional polyester additionally comprises hydroxyl groups.

As mentioned above, in the multilayer system according to the invention coating composition a) cures rapidly even without any irradiation with visible and/or ultraviolet light. Nevertheless, it may be desirable to further increase the curing speed by irradiation with visible and/or ultraviolet light. Accordingly, in one embodiment of the invention coating composition a) comprises a photolatent base. Suitable photolatent bases include N-substituted 4-(o-nitrophenyl) dihydropyridines, optionally substituted with alkyl ether and/or alkyl ester groups, and quaternary organo-boron photoinitiators. An example of an N-substituted 4-(o-nitrophenyl) dihydropyridine is N-methyl nifedipine (Macromolecules 1998, 31, 4798), N-butyl nifedipine, N-butyl 2,6-dimethyl 4-(2-nitrophenyl) 1,4-dihydropyridine 3,5-dicarboxylic acid diethyl ester, and a nifedipine according to the following formula

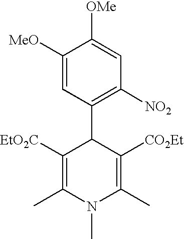

i.e., N-methyl 2,6-dimethyl 4-(4,5-dimethoxy-2-nitrophenyl) 1,4-dihydropyridine 3,5-dicarboxylic acid diethyl ester. Examples of quaternary, organo-boron photoinitiators are disclosed in GB 2307473 A, such as

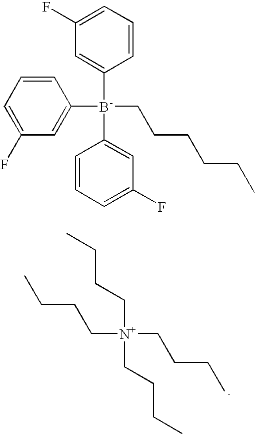

Thus far optimum results have been obtained with a photolatent base belonging to the group of α-amino acetophenones. Examples of α-amino acetophenones which can be used in the photoactivatable coating compositions according to the present invention are: 4-(methylthiobenzoyl)-1-methyl-1-morpholinoethane (Irgacure® 907 ex Ciba Specialty Chemicals) and (4-morpholinobenzoyl)-1-benzyl-1-dimethylamino propane (Irgacure® 369 ex Ciba Specialty Chemicals) disclosed in EP 0898202 A. Preferred is an α-amino acetophenone according to the following formula

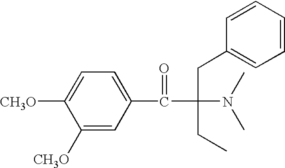

The photolatent base may be used in an amount of between 0.01 and 10 wt. % on solid curable material of coating composition a), preferably 0.05 to 5 wt. %, more preferably 0.05 to 3 wt. %.

If coating composition a) comprises a photolatent base, it is radiation curable after application and, optionally, evaporation of solvents. Curing by irradiation with UV light is particularly suitable. Combinations of IR/UV irradiation are also suitable. Radiation sources which may be used are those customary for UV, such as high- and medium-pressure mercury lamps. In order to avoid any risk involved in handling UV light of very short wave length (UV B and/or UV C light), preference is given, especially for use in automotive refinishing shops, to fluorescent lamps which produce the less injurious UV A light. When a photolatent base is used in coating composition a), a sensitizer may optionally be included in coating composition a) in order to reduce a possible oxygen inhibition during irradiation with UV light from fluorescent lamps. Suitable sensitizers are thioxanthones such as isopropyl thioxanthone according to the following formula

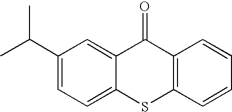

(Quantacure® ITX ex G. Lakes), oxazines, and rhodamines. Colourless surfaces can be obtained with benzophenone and derivatives thereof. Examples of suitable derivatives of benzophenone are:

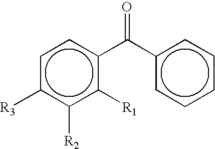

wherein R₁, R₂, and R₃ may be the same or different and stand for CH₃ or H (Speedcure® BEM ex Lambson),

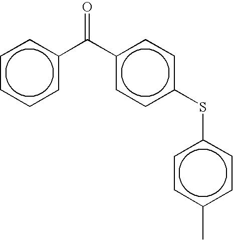

(Quantacure® BMS ex G. Lakes), and

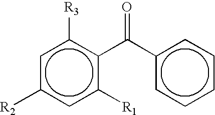

wherein R₁, R₂, and R₃ may be the same or different and stand for CH₃ or H (Esacure® TZT ex Lamberti).

The sensitizer may be present in amount of 0.1 to 5 wt % on solid curable material in coating composition a), preferably 0.5 to 2.5 wt. %.

In addition to the isocyanate-functional compound and the thiol-functional compound as described above, other compounds can be present in coating composition a). Such compounds may be main binders and/or reactive diluents, optionally comprising reactive groups which may be crosslinked with the aforesaid functional compounds. Examples include hydroxyl-functional binders, e.g., polyester polyols, polyether polyols, polyacrylate polyols, polyurethane polyols, cellulose acetobutyrate, hydroxyl-functional epoxy resins, alkyds, and dendrimeric polyols such as described in International patent application WO 9317060. Also, hydroxyl-functional oligomers and monomers, such as castor oil and trimethylol propane, may be present.

Coating composition a) can also comprise latent hydroxyl-functional compounds such as compounds comprising bicyclic orthoester or spiro-orthoester groups. These compounds and their use are described in WO 9731073.

Finally, ketone resins, asparagyl acid esters, and latent or non-latent amino-functional compounds such as oxazolidines, ketimines, aldimines, duimines, secondary amines, and polyamines can be present. These and other compounds are known to the skilled person and are mentioned, int. al., in U.S. Pat. No. 5214086.

The ratio of isocyanate-functional to thiol-functional groups in coating composition a) suitably is between 0.5:1 and 3:1, preferably 0.8:1 to 2:1.

Coating composition a) may further comprise other ingredients, additives or auxiliaries commonly used in coating compositions, such as pigments, dyes, emulsifiers (surfactants), pigment dispersion aids, levelling agents, wetting agents, anti-cratering agents, antifoaming agents, antisagging agents, heat stabilizers, light stabilizers, UV absorbers, antioxidants, and fillers. If hydroxyl-functional compounds are present in coating composition a), the composition preferably comprises one or more catalysts for the crosslinking of isocyanate groups with hydroxyl groups. Examples thereof include Sn-based catalysts, such as dibutyl tin dilaurate, dibutyl tin diacetate, and tin octoate.

As mentioned above, the non-aqueous coating composition b) comprises an effective amount of a catalyst for the addition reaction of the at least one thiol-functional compound and the at least one isocyanate-functional compound of coating composition a). An effective amount is to be understood as an amount of catalyst causing a measurable decrease of strike-in effect upon application of a clear coat of composition a) on the surface of a base coat layer prepared from coating composition b). An effective amount is also such an amount of catalyst causing a measurable increase in the cure speed of coating composition a) having one common layer boundary with coating composition b) comprising the catalyst, as compared to the cure speed of the same coating composition a) applied on a neutral surface comprising no catalyst. The amount of catalyst employed in coating composition b) depends on the specific catalytic activity of the individual catalyst, on the equivalent weight of the catalyst, on the proportion of other components in coating composition b), on the type of isocyanate-functional functional compound selected, on the desired decrease of strike-in, and on the required cure speed of coating composition a). Therefore, the suitable amount of catalyst in coating composition b) has to be established for every individual case and may vary in very wide ranges. Generally, the amount of catalyst in coating composition b) is in the range of 26 millimol to 10 mol of atalyst per kg of coating composition, preferably 35 millimol to 9 mol per kg, ost preferably 50 millimol to 8 mol per kg.

Suitable catalysts in the non-aqueous coating composition b) are all compounds capable of accelerating the addition reaction of thiol-functional compounds and isocyanate-functional compounds.

Generally, suitable catalysts are basic catalysts. Examples are inorganic basic compounds, such as hydroxides and basic oxides of metals. The hydroxides of lithium, sodium, potassium, calcium, and magnesium may be explicitly mentioned.

Quartemary ammonium hydroxides, such as tetraethylammonium hydroxide, can also be used as catalyst in coating composition b).

Furthermore, amines are suitable catalysts in coating composition b).

Suitable primary amines are, for example, isopropyl amine, butyl amine, ethanol amine, 3-amino-1-propanol, 1-amino-2-propanol, 2-amino-2-methyl-1-propanol or 2-amino-2-methyl-1,3-propane diol. Secondary amines that can be used are, for,example, morpholine, diethyl amine, dibutyl amine, N-methyl ethanol amine, diethanol amine, and diisopropanol amine. Also suitable are diamines and polyamines, such as the addition products of epoxides and ammonia or the addition products of epoxides and primary, secondary or tertiary amines. Tertiary amines are a particularly suitable class of basic catalysts. Examples of suitable tertiary amines include trimethyl amine, triethyl amine, triisopropyl amine, triisopropanol amine, N,N-dimethyl ethanol amine, dimethyl isopropyl amine, N,N-diethyl ethanol amine, 1-dimethyl amino-2-propanol, 3-dimethyl amino-1-propanol, 2-dimethyl amino-2-methyl-1-propanol, N-methyl diethanol amine, triethanol amine, N-ethyl diethanol amine, N-butyl diethanol amine, N,N-dibutyl ethanol amine, and N-ethyl morpholine. N,N-dimethyl ethanol amine is a preferred catalyst in coating composition b).

Also suitable are 1,4-diazabicyclo[2.2.2]octane, 1,8-diazabicyclo[5.4.0]undec-7-ene, 1,5-diazabicylo[4.3.0]non-5-ene, guanidine, guanine, guanosine, melamine, and mixtures and derivatives thereof.

The amine catalyst in coating composition b) can also be an amine-functional, optionally film forming, polymer or resin, such as a (co)polymer of 2-(dimethylamino)ethyl (meth)acrylate.

When the catalyst in coating composition b) is a base, it is preferred that the base is present as such, as compared to being present in blocked or neutralized form.

The catalyst in coating composition b) can alternatively be a metal compound with an organic ligand where the metal is a metal of Groups 3 to 13 of the Periodic Table. Preferably, the metal is a transition metal. More preferably, the metal is a metal of Group 4 of the Periodic Table.

The metal compounds comprise metal salts and/or complexes of organic compounds. The organic compounds are groups having 2 to 40 carbon atoms, optionally comprising atoms such as O, N, and S. The metal salts comprise anions selected from the groups of carboxylates. Examples thereof include propionate, butyrate, pentanoate, 2-ethyl hexanoate, naphthenate, oxalate, malonate, succinate, glutamate, and adipate. The metal complexes comprise ligands selected from the ,group of beta-diketones, alkyl acetoacetates, alcoholates, and combinations thereof. Examples thereof include acetyl acetone (2,4-pentanedione), 2,4-heptanedione, 6-methyl-2,4-heptadione, 2,4-octanedione, propoxide, isopropoxide, and butoxide. Preferably, the metal compound is a metal complex.

Examples of metals include aluminium, titanium, zirconium, and hafnium. Examples of metal complexes include aluminium complexed with 2,4-pentanedione (K-KAT® XC5218 ex King Industries), aluminium triacetyl acetonate, zirconium tetraacetyl acetonate, zirconium tetrabutoxide (Tyzor® NBZ ex Dupont), titanium tetrabutoxide (Tyzor® TBT ex Dupont), zirconium complexed with 6-methyl-2,4-heptadione, K-KAT® XC6212 ex King Industries, aluminium triisopropoxide, and titanium diisopropoxide bis-2,4(pentadionate) (Tyzor® AA ex DuPont).

Still another class of suitable catalysts in coating composition b) are co-catalysts comprising a phosphine and a Michael acceptor, such as described in International patent application WO 0168736. When such co-catalysts are used, it is possible that both components of the co-catalyst, i.e. the phosphine and the Michael acceptor, are present in coating composition b). Alternatively, it is also possible to include only one of the components in coating composition b) and to include the other component in coating composition a). Thus, when coating composition b) comprises a Michael acceptor, coating composition a) may comprise a phosphine. It is equally possible to include the phosphine in coating composition b) and to include the Michael acceptor ion coating composition a). The phosphine employed as one of the co-catalysts is a compound according to the formula Z(PR₂)ₙ, wherein n is an integer of 1 to 6, R is independently selected from an aryl group or (cyclo)alk(en)yl group which may be linear or branched and may or may not contain one or more heteroatoms such as oxygen atoms and halogen atoms, provided that the oxygen heteroatoms are not directly linked to a phosphorus atom. Preferably, R is an alkyl or aryl group, more preferably the alkyl group has 1 to 15 carbon atoms and the aryl group has 6 to 15 carbon atoms.

In the event that n=1, Z is a group according to R. Such compounds are hereinafter referred to as monophosphines. Examples of monophosphines include triphenyl phosphine and trioctyl phosphine.

In the event that n≧2, Z is selected from an arylene group, a (cyclo)alk(en)yl-(id)ene group which may be linear or branched and may or may not contain heteroatoms such as oxygen, phosphorus, nitrogen, provided that the oxygen and nitrogen heteroatoms are not directly linked to a phosphorus atom, and/or groups selected from carboxyl, anhydride, cycloalkyl, aryl, or it may be a single bond. These compounds are hereinafter referred to as polyphosphines. Examples of the polyphosphines include bis (2-diphenylphosphinoethyl) phenylphosphine, 1,4-bis (diphenylphosphino) butane, bis (diphenylphosphino) methane, 1,3-bis(diphenylphosphino)propane, 1,5-bis (diphenylphosphino) pentane, trans-1,2-bis (diphenylphosphine) ethylene, cis-1,2-bis (diphenylphosphino) ethylene, (R)-(+)-2,2′-bis (diphenylphosphino) -1,1′-binaphtyl, tetraphenylbiphosphine, tris 2-(diphenylphosphino) (ethyl) phosphine, 1,1-bis (diphenylphosphino) ethylene, 1,1,1-tris (diphenylphosphinomethyl) ethane, 2,3-bis (diphenylphosphino) maleic anhydride, 1,2-bis (diphenylphosphino) benzene, 1,2-bis (pentafluorophenyl) (phosphino) ethane, (2R,3R)-(−)-2,3-bis (diphenylphosphino) bicyclo [2.2.1] hept-5-ene, and ethylene-bis (2-methoxyphenyl) (phenylphosphine). Preferred are polyphosphines wherein Z is a alkylene group, linear or branched, having 1 to 8 carbon atoms optionally comprising a phosphorus atom and R is an aryl group. The most preferred phosphines are 1,4-bis (diphenylphosphino) butane or triphenylphosphine.

The Michael acceptor preferably comprises one or more olefinically unsaturated groups, the olefinically unsaturated group comprising at least one electron-withdrawing functionality linked to a carbon atom of the unsaturated bond. The olefinically unsaturated bond may be a double or a triple bond. Preferably, the Michael acceptor has a structure according to the following formula I:

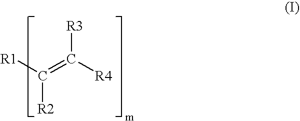

wherein at least one of R1, R2, R3, and R4 comprises an electron-withdrawing functionality linked to a carbon atom of the unsaturated bond and m is an integer from 1 to 6.

Examples of the electron-withdrawing functionality include carbonyl, carboxyl, ester, thiocarbonyl, thiocarboxyl, thioesters, sulfoxide, sulfonyl, sulfo, phosphate, phosphite, phosphonite, phosphinite, nitro, nitrile, and amide.

In the event that m is 1, at least one of R1, R2, R3, and/or R4 comprises the electron-withdrawing functionality and the electron-withdrawing functionality may be attached to a hydrogen atom, linear or branched alkyl, cycloalkyl, alkenyl, cyclo-alkenyl, alkynyl, cyclo-alkynyl, and aryl which may optionally be substituted with various other functionalities, such as carboxylic acid or hydroxide. If they do not comprise an electron-withdrawing functionality, R1, R2, R3, and/or R4 may be independently selected from a hydrogen atom, linear or branched alkyl, cycloalkyl, alkenyl, cyclo-alkenyl, alkynyl, cyclo-alkynyl, and aryl which may optionally be substituted with various functionalities, such as carboxylic acid or hydroxide. R1 and R3 or R2 and R4 may also form a ring comprising one or more electron-withdrawing functionalities.

In the event that m is 2 to 6, R1 is selected from a single bond, an electron-withdrawing functionality, and a polyvalent group derived from a hydrocarbon compound optionally comprising hetero atoms such as —O—, —S—, —Si—, and —P—, groups such as amide, urea, and ester groups, and/or one or more electron-withdrawing functionalities. The hydrocarbon compound may be a substituted or unsubstituted alkane, cycloalkane, alkene, cycloalkene, alkyne, cycloalkyne, arene, or combinations thereof. The polyvalent group is preferably derived from a polyalcohol. Examples of such polyalcohols include trimethylol propane, trimethylol ethane, glycerol, 1,2,6-hexanetriol, ethylene glycol, 1,2-propylene glycol, 1,3-propylene glycol, 2-methylpropane-1,3-diol, neopentyl glycol, 2-butyl-2-ethyl-1,3-propane diol, cyclohexane-1,4-dimethylol, the monoester of neopentyl glycol and hydroxypivalic acid, hydrogenated Bisphenol A, 1,5-pentanediol, 3-methyl-pentanediol, 1,6-hexanediol, 2,2,4-trimethyl pentane-1,3-diol, dimethylol propionic acid, pentaerythritol, di-trimethylol propane, and dipentaerythritol. Alternatively, R3 may also form a ring with R1 comprising one or more electron-withdrawing functionalities.

Examples of Michael acceptors are isobornyl acrylate, isooctyl acrylate, 2,2′-methylene bis (6-t.butyl 4-methyl phenol) monoacrylate, phenoxyethyl acrylate, lauryl acrylate, dicyclopentadiene acrylate, N-butyl maleimide, benzyl acrylate, trimethylol propane tri-acrylate, maleic anhydride, a trifunctional adduct of isophorone diisocyanate to 2-hydroxyethyl maleimide, diethyl maleate, methoxypropyl citraconimide, diethylbenzylidene malonate, or an α,β-unsaturated aldehyde, e.g., cinnamaldehyde or citral. The most preferred Michael acceptors comprise trimethylol propane triacrylate, Irganox 3052 or N-butyl maleimide.

In one embodiment of the multilayer coating system coating composition b) consists essentially of the above-described catalyst and optionally a volatile liquid carrier, such as an organic solvent. In this case, layer b) of the multilayer coating system consists essentially of the above-described catalyst after evaporation of the optional volatile liquid carrier.

In another embodiment coating composition b) also comprises a film-forming binder. The film-forming binder in coating composition b) can be any resin normally used in coatings, such as polyaddition polymer, polyurethane, polyester, polyether, polyamide, polyurea, polyurethane-polyester, polyurethane-polyether, cellulose based binders, such as cellulose acetobutyrate, and/or hybrid resins.

As suitable polyaddition polymer resins may be mentioned the (co)polymers of ethylenically unsaturated monomers. The polyaddition polymer can be prepared by conventional methods of free radical-initiated polymerization. Alternatively, advanced polymerization techniques, such as group transfer polymerization (GTP), atom transfer radical polymerization (ATRP), and reversible addition fragmentation chain transfer (RAFT) polymerization, can also be used for the preparation of polyaddition polymer resins.

The polyaddition polymer may be an acrylic polyol derived from hydroxy-functional acrylic monomers, such as hydroxyethyl (meth)acrylate, hydroxy-propyl (meth)acrylate, hydroxybutyl (meth)acrylate, other acrylic monomers such as (meth)acrylic acid, methyl (meth)acrylate, butyl (meth)acrylate, isobutyl (meth)acrylate, optionally in combination with a vinyl derivative such as styrene, and the like, or mixtures thereof, the terms (meth)acrylate and (meth)acrylic acid referring to both methacrylate and acrylate, as well as methacrylic acid and acrylic acid, respectively. The polyacrylate is prepared by conventional methods, for instance by the slow addition of appropriate monomers to a solution of an appropriate polymerization initiator, such as an azo or peroxy initiator. Preferably, the acrylic polyol is prepared from hydroxy propyl methacrylate, methyl methacrylate, butyl methacrylate, isobutyl methacrylate, styrene, and/or methacrylic acid.

The acrylic polyol may have a hydroxy value of between 25 and 300 mg KOH/g solid resin, preferably between 45 and 250 mg KOH/g solid resin. The number average molecular weight of the polymer may be lower than 25,000, as measured by gel permeation chromatography using polystyrene or polypropylene glycol as a standard. The degree of molecular dispersion, i.e. the ratio of Mw to Mn, preferably is in the range of 1.1. to 10, the range from 1.5 to 5 being particularly preferred. The acid value of the polymer may be between 0 and 50 mg KOH/g solid resin. The glass transition temperature may be above 10° C., preferably between 25 and 85° C.

Suitable resins for coating composition b) according to the invention are polyurethanes. Polyurethanes can be prepared according to generally known methods by reacting.

a) an organic polyisocyanate,

b) one or more polyalcohols selected from
b1) polyalcohols containing 2 to 6 hydroxyl groups and having a number average molecular weight up to 400 and
b2) polymeric polyols having a number average molecular weight between about 400 and about 3,000,

c) optionally compounds containing at least two isocyanate-reactive groups, such as diamines or dithiols,

d) optionally compounds having ionic and/or non-ionic stabilizing groups, and

e) optionally compounds having one isocyanate-reactive group.

As suitable polyester resins may be mentioned the condensation products of a carboxylic acid or a reactive derivative thereof, such as the corresponding anhydride or lower alkyl ester with an alcohol. A polyester polyol is preferred.

The polyester polyol preferably is a branched polyester polyol. More preferably, the branched polyester polyol is the reaction product of
(a) at least one cycloaliphatic and/or aromatic polycarboxylic acid or derivatives thereof,
(b) at least one C₃₋₁₂ triol, and
(c) optionally, one or more monoalcohols, polyols, aromatic polyearboxylic acids, acyclic aliphatic polycarboxylic acids, monocarboxylic acids or glycidyl esters of monocarboxylic acid.

Particularly suitable polyester polyols for film-forming resins and coating composition b) of the present invention have a molecular weight (Mn) ranging from 500 to 5,000, preferably from 750 to 4,000, as determined by gel permeation chromatography using polystyrene or polypropylene glycol as a standard. The degree of molecular dispersion, i.e. the ratio of Mw to Mn, preferably is in the range of 1.1 to 10, ranges from 1.5 to 6 being preferred particularly. The acid value of the polyester polyol preferably is below 30, most preferably below 20. Suitable hydroxyl values are in the range of 50 to 300 mg KOH/g solid resin, preferably 75 to 250 mg KOH/g solid resin. The glass transition temperature may be below 25° C., preferably between 15 and −50° C.

As suitable polyether resins may be mentioned the polymers of cyclic ethers such as ethylene oxide, propylene oxide, other epoxides, oxetane, and tetrahydrofuran.

Suitable cellulose resins for use in coating composition b) are cellulose compounds esterified by at least one monocarboxylic acid. Examples of suitable monocarboxylic acids include monocarboxylic acids containing 2 to 5 carbon atoms, such as acetic acid, propionic acid, and butyric acid. Of course, use may also be made of cellulose resins having different carboxylic acid groups or physical mixtures of different cellulose esters. The cellulose resins generally to be used in actual practice as a rule also contain a small amount of hydroxyl, for instance a few percent by weight. It is preferred that use should be made of a cellulose acetobutyrate. Commercial products include CAB 381-0.1, CAB 381-20, CAB 551-0.2, and CAB 553-0.4 from Eastman Kodak, and mixtures thereof.

Suitable hybrid resins are described in WO 0190265, which is included in this application by reference.

Coating composition b) may optionally comprise at least a second resin. Such a second resin is not identical to the resin already present in composition b) and can be selected from the same group of polyaddition polymer, polyester, polyurethane, polyether resins or a mixture thereof. Suitable polyaddition polymer, polyurethane, polyester, and polyether resins can be selected from the groups as described above.

The non-aqueous coating composition b) may be solvent borne or solvent-free. Coating composition b) optionally comprises a curing agent capable of chemical reaction with the functional groups present in coating composition b). Examples of such functional groups are hydroxyl groups. Examples of suitable curing agents capable of chemical reaction are the polyisocyanates described above. In this case coating composition b) is at least partly curable by chemical reaction.

A minor degree of crosslinking in layer b) can be beneficial for the performance of the multilayer coating system, in particular in view of an improved adhesion between layer a) and layer b). Therefore, in a preferred embodiment coating composition b) is a coating composition which dries essentially by physical drying, i.e. by evaporation of solvent, and to a minor degree by crosslinking. When coating composition b) dries essentially by crosslinking, the mobility and/or availability of the catalyst at the at least one layer boundary of layer a) and layer b) of the multi-layer system according to the invention may be insufficient to effectively cure coating composition a) in layer a). Accordingly, it is preferred that coating composition b) is not a coating composition comprising a polyisocyanate and a thiol-functional compound.

In an especially preferred embodiment coating composition b) comprises a polyacrylate resin, a polyester resin, and a cellulose compound, as described in more detail in WO 0236699.

Coating layer b) preferably is a colour- and/or effect-imparting base coat layer prepared from a base coat composition. Such a base coat composition usually comprises colour- and/or effect-imparting pigments. Colour- and/or effect-imparting pigments are well known in the art. Aluminium particles and mica particles may be specifically mentioned.

The invention also relates to a kit of parts for the preparation of a non-aqueous base coat composition comprising a toner module comprising at least one resin and at least one colour- and/or effect-imparting pigment, a connector module comprising at least one resin compatible with the resin of the toner module, and a reducer module essentially free of resins and pigments, wherein one of the modules comprises an effective amount of a catalyst for the addition reaction of a thiol-functional compound and a isocyanate-functional compound. Preferably, the effective amount of a catalyst for the addition reaction of a thiol-functional compound and an isocyanate-functional compound is comprised in the connector module or in the reducer module.

For the production of the multilayer coating system of the invention coating compositions a) and b) can be applied one after the other without intermediate drying, so called “wet-on-wet” application. Alternatively, there can be an intermediate drying step. The coating compositions a) and b) can be applied in random order and may be a filler composition, a primer composition, a base coat composition, a clear coat composition, and/or a top coat composition. Accordingly, the invention also relates to a process of preparing a multilayer coating system comprising the steps of
(i) applying a layer b) of a non-aqueous coating composition b) comprising an effective amount of a catalyst for the addition reaction of a thiol-functional compound and an isocyanate-functional compound to a substrate,
(ii) prior to or subsequent to the application of layer b) applying a layer a) of a coating composition a) comprising at least one isocyanate-functional compound and at least one thiol-functional compound so that layer a) and layer b) have at least one common layer boundary, and
(iii) curing layer a) at room temperature or elevated temperature, optionally supported by irradiation with UV and/or visible light.

In a preferred embodiment coating composition b) is first applied on an optionally coated substrate and subsequently coating composition a) is applied on top of coating composition b) in order to obtain the multilayer coating system according to the invention.

Application onto a substrate can be via any method known to the skilled person, e.g., via rolling, spraying, brushing, flow coating, dipping, and roller coating. Preferably, at least one of the coating compositions a) and b) as described above is applied by spraying. Most preferably, coating composition a) and coating composition b) are both sprayable coating compositions.

The coating compositions according to the present invention can be applied to any substrate. The substrate may be, for example, metal, e.g., iron, steel, and aluminium, plastic, wood, glass, synthetic material, paper, leather, or another coating layer, such as a primer or filler layer.

Curing temperatures are preferably between 0 and 80° C., and more preferably between 20 and 60° C.

A specific application of the coating system is as a base coat/clear coat system that is often used in the coating of automobiles and transportation vehicles. The coating system and the process are especially useful in the refinish industry, in particular the body shop, to refinish and to repair automobiles. The coating system and the process are also applicable in the automotive industry and for the finishing of large transportation vehicles, such as trains, buses, trucks, and airplanes, and parts thereof.

### EXAMPLES

Raw Materials Used:

Autobase Plus: Commercially available solvent borne modular base coat system from Akzo Nobel Car Refinishes

Q811 B, Q81 IE, Q065,

Q437, Q766, Q726, Q160,

Q911 M, Q673: Commercially available modules of Autobase Plus from Akzo Nobel Car Refinishes

Autoclear LV Ultra: Commercially available clear coat from Akzo Nobel Car Refinishes comprising a polyol and a polyisocyanate crosslinker

1.2.3 Thinner Fast: Commercially available solvent mixture from Akzo Nobel Car Refinishes

Hardener P 25: Commercially available solution of a polyiso-cyanate crosslinker in a solvent mixture under the trade designation Autocryl Plus Hardener P 25 from Akzo Nobel Car Refinishes

Tolonate HDT LV: Polyisocyanate from Rhodia

Desmodur N 3300: Polyisocyanate from Bayer

Sanduvor 3206: Light stabilizer from Clariant

Byk 306: Wetting additive from Byk Chemie

Preparation of a Polyester Polyol 1:

A polyester polyol was prepared from the following components:

| | | |
|---|---|---|
| Hexahydrophthalic anhydride | 13.30 | kg |
| Trimethylol propane | 16.80 | kg |
| Isononanic acid | 6.18 | kg |
| Dimethylolcyclohexane | 0.33 | kg |
| Aqueous solution of 85% phosphoric acid | 0.04 | kg |

The components were placed in a stainless steel reactor equipped with a stirrer, a packed column, a condenser, oil heating, temperature controls, a vacuum line, and a nitrogen inlet. The reaction mixture was heated under a nitrogen stream. The temperature of the mixture was gradually raised to 240° C. The reaction water was distilled off at such a rate that the temperature at the top of the packed column did not exceed 103° C. Finally, a vacuum of 200 mbar was applied while maintaining the nitrogen stream, and the reaction was run at 240° C. for one hour until an acid value below 5 mg KOH/g was reached. The hydroxyl value of the polyester polyol was 269 mg KOH/g. The polyester polyol had an Mn of 1,114 and an Mw of 2,146, as measured by gel permeation chromatography using polystyrene as standard. The reaction product was finally cooled to 130° C. and diluted with n-butyl acetate to give a polyester polyol solution having a solid content of 77%.

Preparation of a Thiol-Functional Polyester:

Into a glass lined reactor equipped with a stirrer, a distillation setup without column, a condenser, oil heating, temperature controls, vacuum, and a nitrogen inlet were charged 19.76 kg of the polyester polyol 1 solution described above. The butylacetate was distilled off at 150° C. at 70 mbar.

3.87 kg 3-mercaptopropionic acid were added at atmospheric pressure. The esterification reaction was carried out at 150° C. under vacuum (maintaining the nitrogen flow) until an acid value of approx. 25 mg KOH/g was reached. A second portion of 1.93 kg 3-mercaptopropionic acid was added. Esterification was continued until an acid value of approx. 30 mg KOH/g. 10 g of methane sulphonic acid were added and the esterification was continued until no more reaction water was collected. 4.98 kg n-butyl acetate were added and distilled off at 150° C. at 10 mbar. The reaction mixture was cooled to 130° C. and diluted with 4.98 kg n-butyl acetate. The product was cooled to 50-60° C. and filtered over a 10-micron filter cloth. A thiol-functional polyester was obtained with a solid content of 80.0%, an acid value of 10 mg KOH/g, an SH-value of 146 mg KOH/g, and a hydroxyl value of 61 mg KOH/g, all based on solids. The thiol-functional polyester had an Mn of 1,126 and an Mw of 2,297, as measured by gel permeation chromatography using polystyrene as a standard.

Preparation of Polyester Polyol 2

A polyester polyol as described in WO 02098942 was prepared from trimethylolpropane, cortic acid, and hexahydrophthalic anhydride. Polyester polyol 2 had a solids content of 100%, and OH value of 306 mg KOH/g, and a number average molecular weight of 800 g/mol.

Preparation of a Coating Composition a1) Comprnsing an Isocyanate-Functional Compound and Thiol-Functional Compounds:

A sprayable clear coat composition having a molar ratio of isocyanate-reactive groups to isocyanate groups of 100 to 150 was prepared by mixing the following components:

| | | |
|---|---|---|
| pentaerythritol tetrakis(3-mercapto propionate) | 250 | g |
| thiol-functional polyester solution as prepared above | 579 | g |
| n-butyl acetate | 616 | g |
| Sanduvor 3206 | 24 | g |
| Byk 306 | 11 | g |
| 10 weight-% solution of dibutyl tin dilaurate in n-butyl | 20 | g |
| acetate/xylene 1:1 | | |
| Tolonate HDT LV | 1000 | g |

Preparation of a Coating Composition a2) Comprising an Isocyanate-Functional Compound and Thiol-Functional Compounds:

A sprayable clear coat composition having a molar ratio of isocyanate-reactive groups to isocyanate groups of 100 to 100 was prepared by mixing the following components:

| | | |
|---|---|---|
| pentaerythritol tetrakis(3-mercapto propionate) | 250 | g |
| thiol-functional polyester solution as prepared above | 579 | g |
| n-butyl acetate | 449 | g |
| Sanduvor 3206 | 24 | g |
| Byk 306 | 11 | g |
| 10 weight-% solution of dibutyl tin dilaurate in n-butyl | 20 | g |
| acetate/xylene 1:1 | | |
| Tolonate HDT LV | 667 | g |

Preparation of a Coating Composition a3) Comprising an Isocyanate-Functional Compound and Thiol-Functional Compounds:

A sprayable clear coat composition having a molar ratio of isocyanate-reactive groups to isocyanate groups of 100 to 60 was prepared by mixing the following components:

| | | |
|---|---|---|
| pentaerythritol tetrakis(3-mercapto propionate) | 250 | g |
| thiol-functional polyester solution as prepared above | 579 | g |
| n-butyl acetate | 316 | g |
| Sanduvor 3206 | 24 | g |
| Byk 306 | 11 | g |
| 10% solution of dibutyl tin dilaurate in n-butyl | 20 | g |
| acetate/xylene 1:1 | | |
| Tolonate HDT LV | 400 | g |

Preparation of a Non-Aqueous Coating Composition b1) According to the Invention:

A physically drying sprayable solvent borne purple metallic base coat composition was prepared by mixing the following components:

| | |
|---|---|
| Q811B (effect toner module) | 47 g |
| Q766 (colour toner module) | 30 g |
| Q065 (connector module) | 23 g |
| Solution of 0.45 g N,N-dimethyl ethanolamine in | 45 g |
| 44.55 g 1.2.3 Thinner Fast (reducer module) | |

Preparation of a Comparative Non-Aqueous Coating Composition b2):

A physically drying sprayable solvent borne purple metallic base coat composition was prepared by mixing the following components:

| | |
|---|---|
| Q811B (effect toner module) | 47 g |
| Q766 (colour toner module) | 30 g |
| Q065 (connector module) | 23 g |
| 1.2.3 Thinner Fast (reducer module) | 45 g |

Preparation of a Non-Aqueous Coating Composition b3) According to the Invention:

An essentially physically drying sprayable solvent borne purple metallic base coat composition comprising a minor amount of a crosslinker was prepared by mixing the following components:

| | | |
|---|---|---|
| Q811B (effect toner module) | 38.5 | g |
| Q726 (colour toner module) | 38.5 | g |
| Q065 (connector module) | 23 | g |
| Hardener P 25 | 10 | g |
| Solution of 0.45 g N,N-dimethyl ethanolamine in | 45 | g |
| 44.55 g 1.2.3 Thinner Fast (reducer module) | | |

Preparation of a Comparative Non-Aqueous Coating Composition b4):

An essentially physically drying sprayable solvent borne purple metallic base coat composition comprising a minor amount of a crosslinker was prepared by mixing the following components:

| | | |
|---|---|---|
| Q811B (effect toner module) | 38.5 | g |
| Q766 (colour toner module) | 38.5 | g |
| Q065 (connector module) | 23 | g |
| Hardener P 25 | 10 | g |
| 1.2.3 Thinner Fast (reducer module) | 45 | g |

Multilayer coating systems were prepared by applying and drying base coat layers from coating compositions b1) to b4) to primed aluminium panels as prescribed in the technical documentation of Autobase Plus. The dry layer thickness of the base coats was about 15 to 20 μm.

Subsequently, the sprayable clear coat compositions a1) to a3) as described above were spray applied on the base coat layers. The applied clear coats had a dry layer thickness of about 45 to 55 μm. The clear coats were allowed to dry at room temperature (23° C).

Strike-in was determined visually on a scale of 0 to 8, wherein 0 represents severe colour differences as compared to the reference panel 3, which was judged 8.

Drying of the clear coats was determined manually. The clear coat was considered dust-dry when gentle rubbing with the thumb hardly left a mark. A tuft of wadding, dropped on the paint, could be blown off. The clear coat was considered dry-to-handle when the mark from firm pushing with the thumb disappeared after 1-2 minutes.

In Example B the commercially available clear coat Autoclear LV Ultra was applied and dried on top of a base coat layer as prescribed in the technical documentation of Autoclear LV Ultra. Panel 3 served merely as reference for strike-in.

Multilayer coating systems according to the invention 1 to 4 and Comparative Examples A, C, D, and E, and the results obtained are summarized in Table 1 below.

TABLE 1

| | | | | Drying speed of | |
|---|---|---|---|---|---|
| Example | Panel | Base coat | Clear coat | clear coat | Strike-in |
| 1 | 1 | Coating | Coating | Dust-dry: 20 min. | 7 |
| | | composition b1) | composition a1) | Dry-to-handle: 2 h | |
| A | 2 | Coating | Coating | Dust dry: >270 min. | 3 |
| | | composition b2) | composition a1) | | |
| B | 3 | Coating | Autoclear | | 8 |
| | | composition b2) | LV Ultra | | |
| 2 | 4 | Coating | Coating | Dust-dry: 40 min | 7 |
| | | composition b3) | composition a1) | Dry-to-handle: 8 h | |
| 3 | 5 | Coating | Coating | Dust-dry: 35 min | 7 |
| | | composition b3) | composition a2) | Dry-to-handle: 8 h | |
| 4 | 6 | Coating | Coating | Dust-dry: 50 min | 7 |
| | | composition b3) | composition a3) | Dry-to-handle: 8 h | |
| C | 7 | Coating | Coating | Dust-dry: >270 min. | 3 |
| | | composition b4) | composition a1) | | |
| D | 8 | Coating | Coating | Dust-dry: >270 min. | 3 |
| | | composition b4) | composition a2) | | |
| E | 9 | Coating | Coating | Dust-dry: >270 min. | 3 |
| | | composition b4) | composition a3) | | |

From Table 1 it can be inferred that the clear coat layers in the comparative multilayer coating systems of Comparative Examples A, C, D, and E on panels 2, 7, 8, and 9 require a rather long time to become dust-dry.

The clear coat layers in the multilayer coating systems according to the invention of Examples 1, 2, 3, and 4 on panels 1, 4, 5, and 6 exhibit significantly faster drying.

Furthermore, strike-in in the comparative multilayer coating systems of Comparative Examples A, C, D, and E on panels 2, 7, 8, and 9 is at an unacceptable level, whereas strike-in in the multilayer coating systems of Examples 1, 2, 3, and 4 according to the invention on panels 1, 4, 5, and 6 is only minimal and almost at the level of the reference of Example B on panel 3.

Preparation of a Radiation Curable Coating Composition a4) Comprising an Isocyanate-Functional Compound and Thiol-Functional Compounds:

A sprayable clear coat composition was prepared by mixing the following components:

| | | |
|---|---|---|
| pentaerythritol tetrakis(3-mercapto propionate) | 429 | g |
| thiol-functional polyester solution as prepared above | 429 | g |
| n-butyl acetate | 561 | g |
| Sanduvor 3206 | 25 | g |
| Byk 306 | 12 | g |
| 10 weight-% solution of dibutyl tin dilaurate in n-butyl | 20 | g |
| acetate/xylene 1:1 | | |
| α-Amino acetophenone photolatent base | 10 | g |
| Tolonate HDT LV | 1294 | g |

Preparation of a Comparative Non-Aqueous Coating Composition b5):

A physically drying sprayable solvent borne base coat composition was prepared by mixing the following components:

| | | |
|---|---|---|
| Q811E (effect toner module) | 48.5 | g |
| Q911M (effect toner module) | 9.8 | g |
| Q437 (colour toner module) | 2.2 | g |
| Q 766 (colour toner module) | 3.9 | |
| Q160 (colour toner module) | 4.4 | g |
| Q673 (colour toner module) | 10.9 | |
| Q065 (connector module) | 23 | g |
| 1.2.3 Thinner Fast (reducer module) | 45 | g |

Preparation of a Comparative Non-Aqueous Coating Composition b6):

An essentially physically drying sprayable solvent borne base coat composition comprising a minor amount of a crosslinker was prepared similar to coating composition b5). Coating composition b6) contained as additional component 5 g of a 77 weight-% solution of Tolo nate HOT LV in n-b utyl acetate.

Preparation of a Non-Aqueous Coating Composition b7) According to the Invention:

An essentially physically drying sprayable solvent borne base coat composition comprising a minor amount of a crosslinker was prepared similar to coating composition b6). The reducer module of coating composition b7) consisted of 45 g of a solution of 0.225 g N,N-dimethyl ethanolamine in 44.775 g 1.2.3 Thinner Fast.

Preparation of a Non-Aqueous Coating Composition b8) According to the Invention:

An essentially physically drying sprayable solvent borne base coat composition comprising a minor amount of a crosslinker was prepared similar to coating composition b6). The reducer module of coating composition b8) consisted of 45 g of a solution of 0.45 g N,N-dimethyl ethanolamine in 44.55 g 1.2.3 Thinner Fast.

Preparation of a Non-Aqueous Coating Composition b9) According to the Invention:

An essentially physically drying sprayable solvent borne base coat composition comprising a minor amount of a crosslinker was prep red similar to coating composition b6). The reducer module of coating composition b9) consisted of 45 g of a solution of 1.35 g N,N-dimethyl ethanolamine in 43.65 g 1.2.3 Thinner Fast.

Preparation of a Non-Aqueous Coating Composition b10) According to the Invention:

An essentially physically drying sprayable solvent borne base coat composition comprising a minor amount of a crosslinker was prepared similar to coating composition b6). The reducer module of coating composition b10) consisted of 45 g of a solution of 2.25 g N,N-dimethyl ethanolamine in 42.75 g 1.2.3 Thinner Fast.

Multilayer coating systems were prepared by applying and drying base coat layers from coating compositions b5) to b10) to primed aluminium panels as prescribed in the technical documentation of Autobase Plus. The dry layer thickness of the base coats was about 15 to 20 μm.

Subsequently, the sprayable clear coat composition a4) as described above was spray applied on the base coat layers. The applied clear coats had a dry layer thickness of about 45 to 55 μm. After application, the clear coats were cured by irradiation with UV-A light from a TL K 40/10-R fluorescent tube ex Philips for 5 minutes.

Multilayer coating systems according to the invention 5 to 8 and comparative Examples F and G, and the results obtained are summarized in Table 2 below.

TABLE 2

| Example | Panel | Base coat | Clear coat | Strike-in |
|---|---|---|---|---|
| F | 10 | Coating | Coating | 3 |
| | | composition b5) | composition a4) | |
| G | 11 | Coating | Coating | 5 |
| | | composition b6) | composition a4) | |
| 5 | 12 | Coating | Coating | 6 |
| | | composition b7) | composition a4) | |
| 6 | 13 | Coating | Coating | 7 |
| | | composition b8) | composition a4) | |
| 7 | 14 | Coating | Coating | 8 |
| | | composition b9) | composition a4) | |
| 8 | 15 | Coating | Coating | 8 |
| | | composition b10) | composition a4) | |

From Table 2 it can be inferred that the comparative multilayer coating systems F and G show an unacceptable level of strike-in. Although the addition of a polyisocyanate crosslinker in base coat composition b6) reduces strike-in, the level of strike-in in comparative Example G is still not fully satisfactory. In the multilayer coating systems of Examples 5 to 8 the level of strike-in is acceptable to very low. Examples 5 to 8 represent multilayer coating systems wherein coating compositions b7) to b10) comprise an increasing amount of a basic catalyst. A higher amount of basic catalyst in the base coat composition leads to a lower level of strike-in in the multilayer system.

Preparation of a Non-Aqueous Coating Composition b11) According to the Invention:

A physically drying sprayable solvent borne blue metallic base coat composition was prepared by mixing the following components:

| | | |
|---|---|---|
| Q811E (effect toner module) | 48.5 | g |
| Q911M (effect toner module) | 9.8 | g |
| Q437 (colour toner module) | 2.2 | g |
| Q 766 (colour toner module) | 3.9 | |
| Q160 (colour toner module) | 4.4 | g |
| Q673 (colour toner module) | 10.9 | |
| Q065 (connector module) | 23 | g |
| Solution of 2.2 g Zirconium (IV) acetylacetonate in | 43.5 | g |
| 41.3 g of a mixture of 1.2.3 Thinner Fast and Xylene | | |
| (reducer module) | | |

Preparation of a Non-Aqueous Coating Composition b12) According to the Invention:

A physically drying sprayable solvent borne blue metallic base coat composition was prepared by mixing the following components:

| | | |
|---|---|---|
| Q811E (effect toner module) | 48.5 | g |
| Q911M (effect toner module) | 9.8 | g |
| Q437 (colour toner module) | 2.2 | g |
| Q 766 (colour toner module) | 3.9 | |
| Q160 (colour toner module) | 4.4 | g |
| Q673 (colour toner module) | 10.9 | |
| Q065 (connector module) | 23 | g |
| Solution of 2.2 g aluminium isopropoxide in | 43.5 | g |
| 41.3 g of a mixture of 1.2.3 Thinner Fast and Xylene | | |
| (reducer module) | | |

Preparation of a Comparative Non-Aqueous Coating Composition b13):

A physically drying sprayable solvent borne blue metallic base coat composition was prepared by mixing the following components:

| | | |
|---|---|---|
| Q811E (effect toner module) | 48.5 | g |
| Q911M (effect toner module) | 9.8 | g |
| Q437 (colour toner module) | 2.2 | g |
| Q 766 (colour toner module) | 3.9 | |
| Q160 (colour toner module) | 4.4 | g |
| Q673 (colour toner module) | 10.9 | |
| Q065 (connector module) | 23 | g |
| 1.2.3 Thinner Fast (reducer module) | 43.5 | g |

Preparation of a Non-Aqueous Coating Composition b14) According to the Invention:

A physically drying sprayable solvent borne blue metallic base coat composition was prepared by mixing the following components:

| | | |
|---|---|---|
| Q811E (effect toner module) | 48.5 | g |
| Q911M (effect toner module) | 9.8 | g |
| Q437 (colour toner module) | 2.2 | g |
| Q 766 (colour toner module) | 3.9 | |
| Q160 (colour toner module) | 4.4 | g |
| Q673 (colour toner module) | 10.9 | |
| Q065 (connector module) | 23 | g |
| 25 weight-% solution of triphenyl phosphine in xylene | 30.3 | g |
| (reducer module) | | |
| 1.2.3 Thinner Fast (reducer module) | 12.6 | g |

Preparation of a Non-Aqueous Coating Composition b15) According to the Invention:

A physically drying sprayable solvent borne blue metallic base coat composition was prepared by mixing the following components:

| | | |
|---|---|---|
| Q811E (effect toner module) | 48.5 | g |
| Q911M (effect toner module) | 9.8 | g |
| Q437 (colour toner module) | 2.2 | g |
| Q 766 (colour toner module) | 3.9 | |
| Q160 (colour toner module) | 4.4 | g |
| Q673 (colour toner module) | 10.9 | |
| Q065 (connector module) | 23 | g |
| 25 weight-% solution of trimethylolpropane triacrylate | 7.6 | g |
| in butyl acetate (reducer module) | | |
| 1.2.3 Thinner Fast (reducer module) | 35.8 | g |

Preparation of a Radiation Curable Coating Composition a5) Comprising an Isocyanate-Functional Compound and Thiol-Functional Compounds:

A sprayable clear coat composition was prepared by mixing the following components:

| | | |
|---|---|---|
| pentaerythritol tetrakis(3-mercapto propionate) | 429 | g |
| thiol-functional polyester solution as prepared above | 429 | g |
| n-butyl acetate | 561 | g |
| Sanduvor 3206 | 25 | g |
| Byk 306 | 12 | g |
| 25 weight-% solution of trimethylolpropane triacrylate | 70 | g |
| in butyl acetate | | |
| 10 weight-% solution of dibutyl tin dilaurate in n-butyl | 20 | g |
| acetate/xylene 1:1 | | |
| α-Amino acetophenone photolatent base | 10 | g |
| Tolonate HDT LV | 1294 | g |

Preparation of a Radiation Curable Coating Composition a6) Comprising an Isocyanate-Functional Compound and Thiol-Functional Compounds:

A sprayable clear coat composition was prepared by mixing the following components:

| | | |
|---|---|---|
| pentaerythritol tetrakis(3-mercapto propionate) | 429 | g |
| thiol-functional polyester solution as prepared above | 429 | g |
| n-butyl acetate | 561 | g |
| Sanduvor 3206 | 25 | g |
| Byk 306 | 12 | g |
| 25 weight-% solution of triphenyl phosphine in xylene | 278 | g |
| 10 weight-% solution of dibutyl tin dilaurate in n-butyl | 20 | g |
| acetate/xylene 1:1 | | |
| α-Amino acetophenone photolatent base | 10 | g |
| Tolonate HDT LV | 1294 | g |

Multilayer coating systems were prepared by applying and drying base coat layers from coating compositions b11) to b15) to primed aluminium panels as prescribed in the technical documentation of Autobase Plus. The dry layer thickness of the base coats was about 15 to 20 μm.

Subsequently, the sprayable clear coat composition a4) as described above was spray applied on base coat layers b11) to b13). Clear coat composition a5) was applied on base coat b14), and clear coat composition a6) was applied on., base coat b15). The applied clear coats had a dry layer thickness of about 45 to 55 μm. The clear coats were allowed to dry at room temperature, without irradiation with UV light.

Multilayer coating systems according to the invention 9 to 12 and Comparative Example H and the results obtained are summarized in Table 3 below.

TABLE 3

| | | | | Drying speed of | |
|---|---|---|---|---|---|
| Example | Panel | Base coat | Clear coat | clear coat | Strike-in |
| 9 | 16 | Coating | Coating | Dust-dry: 3 h | 5 |
| | | composition b11) | composition a4) | Dry-to-handle: 4 h | |
| 10 | 17 | Coating | Coating | Dust-dry: 3 h | 8 |
| | | composition b12) | composition a4) | Dry-to-handle: 4 h | |
| H | 18 | Coating | Coating | Dust-dry: 5.5 h | 3 |
| | | composition b13) | composition a4) | Dry-to-handle: 7 h | |
| 11 | 19 | Coating | Coating | Not determined | 7 |
| | | composition b14) | composition a5) | | |
| 12 | 20 | Coating | Coating | Not determined | 5 |
| | | composition b15) | composition a6) | | |

From Table 3 it can be inferred that also metal compounds with an organic ligand where the metal is a metal of Groups 3 to 13 of the Periodic Table are suitable catalysts which can be included in coating composition b) in order to reduce the strike-in effect and to increase the drying speed of coating composition a). Also a component of a co-catalyst in coating composition b) reduces strike-in when the clear coat comprises the counter component of the co-catalyst.

Preparation of a Comparative Coating Composition a7) Comprising an Isocyanate-Functional Compound and a Hydroxyl-Functional Binder:

A sprayable clear coat composition was prepared by mixing the following components:

| | | |
|---|---|---|
| Polyester polyol 2 | 48.5 | g |
| n-butyl acetate | 65 | g |
| 10 weight-% solution of dibutyl tin dilaurate in n-butyl | 4.0 | g |
| acetate | | |
| Byk 306 | 0.3 | g |
| Desmodur n 3300 | 51.5 | g |

Preparation of a Comparative Coating Composition a8) Comprising an Isocyanate-Functional Compound and a Hydroxyl-Functional Binder:

A sprayable clear coat composition was prepared by mixing the following components:

| | | |
|---|---|---|
| Polyester polyol 2 | 48.5 | g |
| n-butyl acetate | 55 | g |
| Byk 306 | 0.3 | g |
| Desmodur n 3300 | 38 | g |

Preparation of Comparative Non-Aqueous Coating Composition b16)

A coating composition was prepared in analogy to coating composition b13). 1.3 g of 1.2.3 Thinner Fast of the reducer module were replaced with 1.3 g of a 10 weight-% solution of dibutyl tin dilaurate in n-butyl acetate.

Preparation of Comparative Non-Aqueous Coating Composition b17)

A coating composition was prepared in analogy to coating composition b13). 0.21 g of 1.2.3 Thinner Fast of the reducer module was replaced with 0.21 g of a 10 weight-% solution of dibutyl tin dilaurate in n-butyl acetate.

Comparative multilayer coating systems were prepared as described above from the base coat and clear coat compositions as summarized in Table 4 below.

TABLE 4

| Example | Panel | Base coat | Clear coat | Strike-in |
|---|---|---|---|---|
| I | 21 | Coating | Coating | 3-4 |
| | | composition b13) | composition a4) | |
| J | 22 | Coating | Coating | 3 |
| | | composition b17) | composition a4) | |
| K | 23 | Coating | Coating | 1 |
| | | composition b16) | composition a4) | |
| L | 24 | Coating | Coating | 3 |
| | | composition b13) | composition a7) | |
| M | 25 | Coating | Coating | 1 |
| | | composition b16) | composition a7) | |
| N | 26 | Coating | Coating | 2 |
| | | composition b13) | composition a8) | |
| O | 27 | Coating | Coating | 0 |
| | | composition b17) | composition a8) | |

From comparative Examples I to K it can be inferred that addition of dibutyl tin dilaurate, which is not a catalyst for the reaction of thiol-functional compounds and isocyanate-functional compounds, to base coat compositions does not solve the problem of strike-in when the clear coat comprises a thiol-functional compound and an isocyanate-functional compound. Actually, the addition of dibutyl tin dilaurate to the base coat even aggravates the strike-in effect (cf. comparative Examples J and K with dibutyl tin dilaurate in the base coat versus comparative Example I without dibutyl tin dilaurate in the base coat). From comparative Examples L to O it can be inferred that the addition of dibutyl tin dilaurate to base coat compositions does not solve the problem of strike-in when the clear coat comprises a hydroxyl-functional binder and an isocyanate-functional crosslinker. Actually, the addition of dibutyl tin dilaurate to the base coat even aggravates the strike-in effect (cf. comparative Examples M and O with dibutyl tin dilaurate in the base coat versus comparative Examples L and N without dibutyl tin dilaurate in the base coat).

1. A multilayer coating system comprising
at least one layer a) comprising a coating composition a) comprising at least one isocyanate-functional compound and at least one thiol-functional compound, and
at least one layer b) comprising a non-aqueous coating composition b),
at least one layer a) and at least one layer b) having at least one common layer boundary, characterized in that coating composition b) comprises an effective amount of a catalyst for the addition reaction of the at least one thiol-functional compound and the at least one isocyanate-functional compound.

2. A multilayer coating system according to claim 1, characterized in that coating composition a) comprises pentaerythritol tetrakis(3-mercapto propionate).

3. A multilayer coating system according to claim 1, characterized in that coating composition a) comprises a thiol-functional polyester.

4. A multilayer coating system according to claim 3, characterized in that the thiol-functional polyester additionally comprises hydroxyl groups.

5. A multilayer coating system according to claim 1, characterized in that coating composition a) comprises pentaerythritol tetrakis(3-mercapto propionate) and a thiol-functional polyester.

6. A multilayer coating system according to claim 1, characterized in that coating composition a) comprises a photolatent base.

7. A multilayer coating system according to claim 6, characterized in that the photolatent base is an OL-amino acetophenone.

8. A multilayer coating system according to claim 1, characterized in that layer a) is a clear coat layer.

9. A multilayer coating system according to claim 1, characterized in that the catalyst for the addition reaction of the at least one thiol-flnctional compound and the at least one isocyanate-functional compound in coating composition b) is a tertiary amine.

10. A multilayer coating system according to claim 9, characterized in that the tertiary amine is N,N-dimethyl ethanolamine.

11. A multilayer coating system according to claim 1, characterized in that the catalyst for the addition reaction of the at least one thiol-functional compound and the at least one isocyanate-functional compound in coating composition b) is a metal compound with an organic ligand where the metal is a metal of Groups 3 to 13 of the Periodic Table.

12. A multilayer coating system according to claim 1, characterized in that the catalyst for the addition reaction of the at least one thiol-functional compound and the at least one isocyanate-functional compound in coating composition b) is a co-catalyst comprising a phosphine component and a Michael acceptor component.

13. A multilayer coating system comprising
at least one layer a) comprising a coating composition a) comprising at least one isocyanate-functional compound and at least one thiol-functional compound, and
at least one layer b) comprising a non-aqueous coating composition b),
at least one layer a) and at least one layer b) having at least one conunon layer boundary, characterized in that coating composition b) comprises an effective amount of at least one component of a co-catalyst comprising a phosphine component and a Michael acceptor component, and the other of phosphine component and Michael acceptor component is present in coating composition a).

14. A multilayer coating system according to claim 1, characterized in that layer b) is a colour and/or effect imparting base coat layer.

15. A multilayer coating system according to claim 14, characterized in that coating composition b) is a solvent borne base coat composition.

16. A multilayer coating system according to claim 1, characterized in that coating composition b) comprises a curing agent capable of chemical reaction with functional groups present in coating composition b).

17. A process of preparing a multilayer coating system comprising the steps of
i. applying a layer b) of a non-aqueous coating composition b) comprising an effective amount of a catalyst for the addition reaction of a thiol-functional compound and an isocyanate-functional compound to a substrate,
ii. prior to or subsequent to the application of layer b) applying a layer a) of a coating composition a) comprising at least one isocyanate-functional compound and at least one thiol-functional compound so that layer a) and layer b) have at least one common layer boundary, and
iii. curing layer a) at room temperature or elevated temperature.

18. A process according to claim 17, characterized in that it is implemented for finishing or refinishing of automobiles, large transportation vehicles, or parts thereof.

19. A method of reducing the strike-in effect in a multilayer coating system comprising applying a clear coat composition a) comprising at least one isocyanate-functional compound and at least one thiol-functional compound on top of a base coat layer b) prepared from a non-aqueous base coat composition b) comprising an effective amount of a catalyst for the addition reaction of the at least one thiol-functional compound and the at least one isocyanate-functional compound.

20. A kit of parts for the preparation of a non-aqueous base coat composition comprising a toner module comprising at least one resin and at least one colour and/or effect imparting pigment, a connector module comprising at least one resin compatible with the resin of the toner module, and a reducer module essentially free of resins and pigments, wherein at least one of the reducer module and the connector module comprises an effective amount of a catalyst for the addition reaction of a thiol-functional compound and an isocyanate-flnctional compound.

21. A process according to claim 17, characterized in that the curing is supported by irradiation with UV and/or visible light.
